(19) United States
(12) Patent Application Publication
(10) Pub. No.: US 2010/0057673 A1
(43) Pub. Date: Mar. 4, 2010

(54) REUSABLE MAPPING RULES FOR DATA TO DATA TRANSFORMATION

(76) Inventor: BORIS SAVOV, Sofia (BG)

Correspondence Address: SAP AG, 3410 HILLVIEW AVENUE, PALO ALTO, CA, 94304, US

(21) Appl. No.: 12/203,938

(22) Filed: Sep. 4, 2008

(51) Int. Cl. G06F 17/30

(52) U.S. Cl. 707/2; 707/E17.002

(57) ABSTRACT

What is described is a method and a system for data transformation by using predefined mapping rules. A transformation between a source data object and a target data object is defined and an initial mapping of elements from the source data object to the target data object is created. A predefined mapping rule is applied as a subsequent mapping between the source data object and the target data object to adjust the transformation. The mapping from the source data object to the target data object is displayed via a graphical user interface.

### FIELD OF THE INVENTION

The present invention relates to data transformation. More precisely, the invention relates to data transformation using mapping rules that represent common reusable templates for data transformation defined for sets of sources and target.

### BACKGROUND OF THE INVENTION

Data mapping is the transformation of data for adaptation to a certain usage. It is often necessary to define comprehensive data transformation mappings between complicated data structures in more than one place. Data mapping is the process of creating transformation between the elements of two distinct data scopes. Defining this transformation takes time and is quite error prone. Some tools offer predefined rules for such a transformation, but, because they are implemented programmatically, it is hard for the user to understand what happens “behind the scenes”. Sometimes, graphical tools are used in order to show the relationships between data objects by drawing lines representing the connections between fields from different data scopes. Algorithms are used for creating the mapping automatically, based mainly on the idea of connecting the fields from the two scopes that have the same name. This is usually done when handling heterogeneous data, which makes the mapping a complex problem. There are technologies for overcoming this heterogeneous complexity for relational data sources. The structural heterogeneity is a basic mapping problem in order to find effective mappings between distinct data structures. Facilitating and automating data mapping is one of the fundamental challenges for data interoperability.

### SUMMARY OF THE INVENTION

A computer implemented method and a system for data transformation by using predefined mapping rules are described. In one embodiment, the method includes defining a transformation between a source data object and a target data object and creating an initial mapping of elements from the source data object to the target data object. The method also includes applying a predefined mapping rule as a subsequent mapping between the source data object and the target data object to adjust the transformation, and displaying the mapping from the source data object to the target data object via a graphical user interface.

In one embodiment, the system includes a source data object and a target data object and a mapping module to define a transformation and create an initial mapping of elements from the source data object to the target data object. The system also includes a predefined mapping rule to be applied as a subsequent mapping between the source data object and the target data object to adjust the transformation and a display for showing the mapping from the source data object to the target data object.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a flow diagram of one embodiment for data transformation using mapping rules.

FIG. 2 is a block diagram of one embodiment of a mapping unit for data transformation using mapping rules.

FIG. 3 is a flow diagram of an exemplary process for data transformation using mapping rules.

FIG. 4 is an example of a GUI for showing a data transformation using mapping rules.

FIG. 5 is an example of a GUI showing the collapsed mapping feature.

FIG. 6 is an example of a GUI showing the expanded mapping feature.

FIG. 7 is an example of a GUI showing the collapsed mapping feature.

FIG. 8 is an example of a GUI showing the expanded mapping feature.

### DETAILED DESCRIPTION

What is described is a method and a system for data transformation by using predefined mapping rules. A transformation between a source data object and a target data object is defined and an initial mapping of elements from the source data object to the target data object is created. A predefined mapping rule is applied as a subsequent mapping between the source data object and the target data object to adjust the transformation. The mapping from the source data object to the target data object is displayed via a graphical user interface.

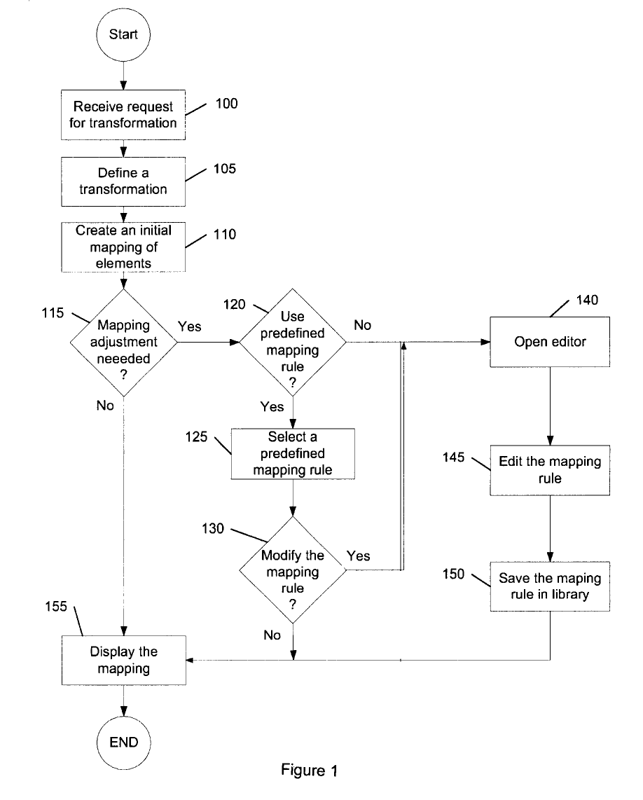

FIG. 1 is a flow diagram of one embodiment for data transformation from a source data object to a target data object. At block 100, a request is received to perform the data transformation. This request may come, for example, through an instruction from a process that operates on a source data object and a target data object. By using a graphical user interface (GUI), such a request may be triggered by simply connecting a source data object to a target data object. The connection can be performed by any pointing input device. At block 105, a transformation between the source data object and the target data object is defined. During this definition, information about the data that is going to be mapped is gathered. The information gathered may consist of the elements of the source data object and the target data object and their structure. For example, some data structures are represented as hierarchies in which nodes represent objects and connections between the nodes represent the relationship between the data objects.

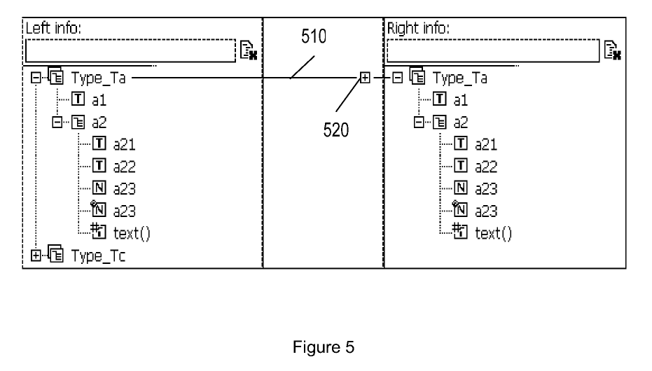

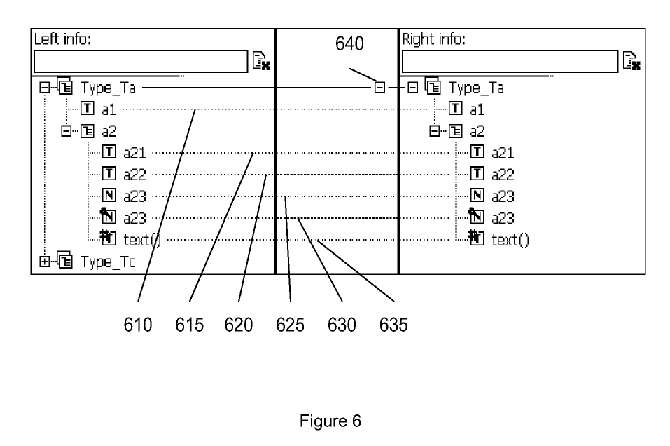

At block 110, the information about the elements and their structure is used to create an initial mapping of the elements of the source data object to the target data object. In one embodiment, all the nodes that consist of the same name or type of data will be mapped. For example, if a direct move corresponding of employee name to employee name or employee record to employee record can be accomplished with the initial mapping, this initial mapping of the same name or type of data will be used. The mapping may arise from one or more source data objects. At processing block 115, it is determined if the initial mapping is suitable for mapping the data from the source data object or objects to the target data object. If the initial mapping is suitable, then at processing block 155, the initial mapping is displayed via a graphical user interface on a display. This represents a “Deep Copy” or move corresponding mapping of the data and is illustrated in reference to FIGS. 5 and 6 below.

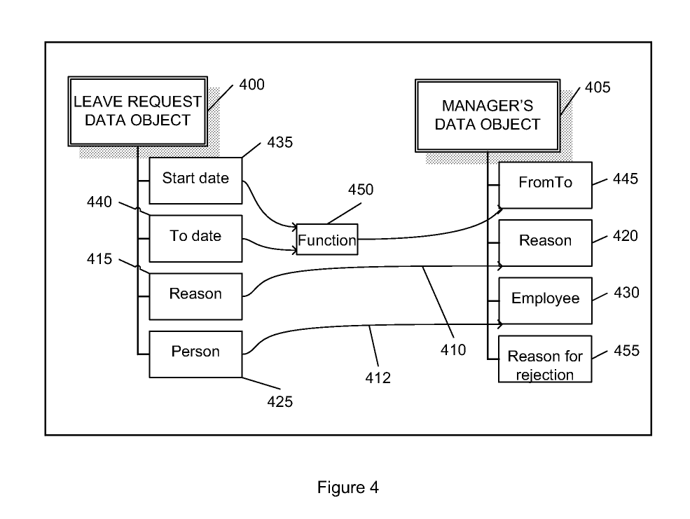

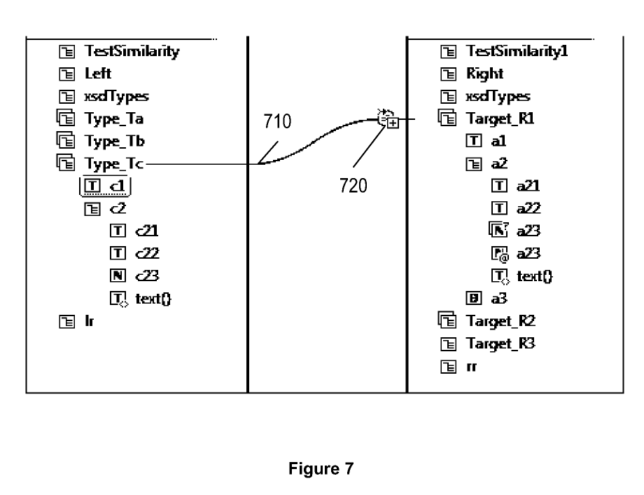

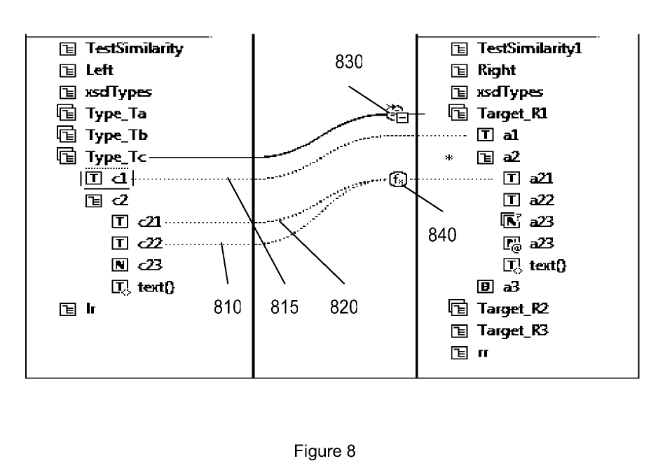

If, at processing block 115, it is determined that the initial mapping is not suitable for the mapping, then, at block 120, it is determined if a predefined mapping rule exists for the mapping between the source data object or objects and the target data object. Predefined mapping rules are common reusable templates for data transformation defined for one ore more source data objects to exactly one target data object. A suitable predefined mapping rule may be chosen either manually or automatically from a set of predefined rules. Libraries with mapping rules may be defined for particular cases for reuse. These libraries of mapping rules are applicable for mapping complex to complex, complex to primitive, primitive to complex or primitive to primitive data types. Primitive types are simple and they do not consist of elements. Complex types of data allow elements in their content and consists of several primitive types. Each data structure is complex type and a single node is primitive type of data. The predefined mapping rules may be used to specify how to map otherwise incompatible context objects. A need for adjustment may appear when mapping assignment-incompatible types of data. For example, when mapping data object 400 to data object 405 in FIG. 4. Source nodes 435 and 440 and the target node 445 need a special transformation that will concatenate the source nodes 435 and 440 to the target node 445. In that case a predefined mapping rule may be used to perform the transformation. In one embodiment, the need for a mapping adjustment is illustrated by the fₓ icon, as shown at 840 in FIG. 8. The fₓ icon is a token for indicating a possible custom transformation from the source data object to the target data object. Clicking on the fₓ icon opens a dialog window in which a custom expression for the transformation may be inserted. This custom expression may be a function to extract a mapping rule for repeating the same transformation. In one embodiment, instead of standart fₓ icon, for the mapping rules can be used specific icons as shown by 720 in FIG. 7 and 830 in FIG. 8.

Referring again to FIG. 1, if, at block 120, it is determined that a predefined mapping rule is to be used as a subsequent mapping, at block 125 a mapping rule is selected. The selected predefined mapping rule may be used as it stands or may be modified, which is determined at block 130. If, at block 130, it is determined not to modify the predefined mapping rule, the subsequent mapping is used and displayed at block 155. If, at block 130, it is determined to modify the predefined mapping rule, an editor opens at block 140 and the mapping rule is edited at block 145. It is possible to use a predefined mapping rule as a compound part of another mapping rule. This is useful in very complex expressions. Adjustment of the mapping rule is necessary, for example, when the available predefined mapping rules cannot perform the data transformation from the source data object or objects to the target data object. In this case, small adjustments to one of the existing predefined mapping rules may be done. In one embodiment, the adjustments are made via a graphical user interface (GUI). The adjusted mapping rule is saved in block 150 for reuse. The subsequent mapping based on the edited predefined mapping rule is used and displayed at block 155.

Referring back to block 120, if no predefined mapping rule is determined to be used as a subsequent mapping between the source data object and the target data object, an editor is opened at block 140. A new mapping rule is edited at block 145 to perform the transformation. At block 150 the new mapping rule is saved for reuse in a library. At block 155 the mapping based on the newly created mapping rule is used and displayed.

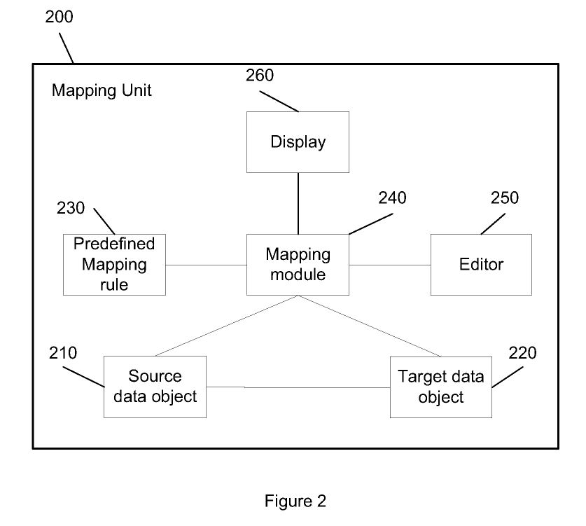

FIG. 2 is a block diagram of one embodiment of a mapping unit 200 for data transformation using mapping rules. A source data object 210 and a target data object 220 represent data structures to be mapped. A mapping module 240 defines a data transformation between the source data object 210 and the target data object 220 and creates an initial mapping of their elements. The mapping module 240 receives a request for the data transformation between the source data object 210 and the target data object 220. This request may come, for example, from a process that operates on the source data object 210 and the target data object 220. By using a graphical user interface (GUI), such a request may be triggered by simply connecting a source data object 210 to a target data object 220. The connection may, for example, be performed by using any pointing input device.

Mapping module 240 determines if the initial mapping needs adjustment. In case the initial mapping created between the source data object 210 and the target data object 220 needs adjustment, mapping module 240 uses a predefined mapping rule 230 as a subsequent mapping. Predefined mapping rules are common reusable templates for data transformation defined for set of sources and target. A suitable predefined mapping rule can be chosen manually or automatically by mapping module 240 from a set of predefined mapping rules. Shared libraries with mapping rules can be defined for particular cases and be reused. The predefined mapping rule 230 can be used as it stands or may be edited using editor 250 for the creation of the subsequent mapping. Editing may be necessary, for example, when the available predefined mapping rules cannot perform the data transformation from the source data object 210 to the target data object 220. The mapping from the source data object 210 to the target data object 220 is displayed via a GUI on display 260. The mapping from the source data object 210 to the target data object 220 can be shown on a display by using a collapse/expand mapping feature. The collapse/expand mapping feature is discussed below in relation to FIGS. 5, 6, 7 and 8.

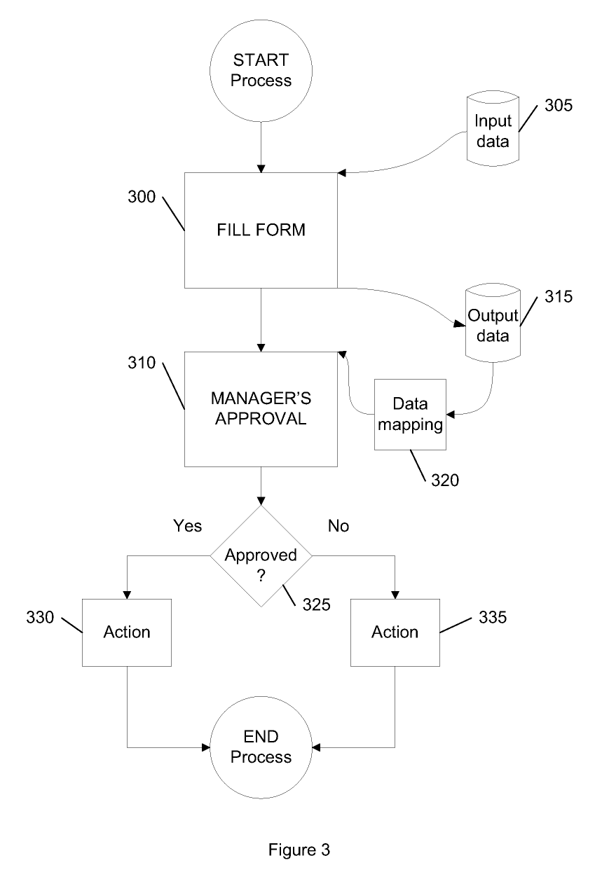

FIG. 3 is a flow diagram of an exemplary process for data transformation using mapping rules. A leave request for an employee starts at block 300 with the employee filling out a form for a leave request. This form has several fields that may be filled in as input data 305. The input data 305 can be, for example, the employee name, the start date, the end date, and the reason for the request. At block 310, the manager's approval is performed. The data in the manager's approval form may be structured in a different manner than the structure of the leave request, although the manager's approval form uses similar data as the leave request. The manager's approval form uses the output data 315 from the leave request form but, before using it, the data is mapped at block 320 to the data structure used in the manager's approval form. For example, the start date and end date may be concatenated in one field in the manager's approval form yet being two fields in the leave request form. The employee name could be substituted by the employee ID number or to be presented together. There could also be some new additional fields, for instance the reason for rejection that would remain unconnected. Therefore, some data transformation is required. This transformation is necessary and is used every time the same types and structures of data are accessed. A predefined mapping rule can be used for this transformation. The predefined mapping rule will be available as a template for any data transformation defined for this set of sources and target. At block 325, the decision for approval or rejection of the leave request is made. According to the decision, corresponding actions are invoked in blocks 330 and 335.

FIG. 4 is an example of a GUI for displaying a data transformation using mapping rules. Block 400 is a leave request data object and block 405 is a manager's data object. The corresponding fields of the leave request data object 400 and manager's data object 405 are connected via lines 410 and 412. These lines represent the transformation from the leave request data object 400 to the manager's data object 405. In this example, both data structures have hierarchic structures. The initial mapping in this case connects the data that is the same in both the source and the target. For example, <Reason> 415 is connected via 410 to <Reason> 420 and <Person> 425 is connected via 412 to <Employee> 430. The <Start date> 435 and <To date> 440 are combined to the <FromTo> 445 field, which requires Function 450 in order to perform the action necessary for the data transformation. This Function 450 may be applied either manually or programmatically. A predefined mapping rule may be used instead of Function 450. The predefined mapping rule defines the relationship between the source data object and the target data object. In the example the mapping rule defines the <Start date> 435 and <To date> 440 as being concatenated to transform the two fields into <FromTo> 445. The node <Reason for rejection> 455 remains unconnected as no transformation is necessary.

Referring to FIGS. 5, 6, 7 and 8, the mapping from the source data object to the target data object can be shown on a display by using a collapse/expand mapping feature. This feature is useful in case of hierarchic data structures organized as trees. In a tree hierarchy, there is a root data object from which other data objects branch. In the situation with a large number of nodes and branches, the displaying of all the connections between the elements of the data structures is difficult to track. In the collapse mode (FIG. 5 and FIG. 7), only the root level connection between the root data objects is presented as shown by lines 510 and 710. The connection indicates that there is a transformation between the source root node and the target root node. Thus the mapping structure is simply shown, but still contains information about the defined data transformations. If the mapping is expanded as shown in FIG. 6 and FIG. 8, all mappings between sources and target nodes are indicated as shown by lines 610, 615, 620, 625, 630, 635 and 810, 815, 820 respectively. These connections may be in a different style in order to distinguish from the root level connection. The transition between the expanded and the collapse mode can be triggered in various ways. For example, a box having a plus or minus sign may be used to switch between the expanded and the collapsed modes. The box may be situated, for example, anywhere on the route of the root level connection (520 in FIG. 5, 640 in FIG. 6, 720 FIG. 7 and 830 in FIG. 8). With plus is defined the top level connection as in FIG. 5 and FIG. 7 and the expanded mode will show large and more complex structures with deep levels as in FIG. 6 and FIG. 8.

The invention can be implemented as a computer program product, i.e. a computer program tangibly embodied in an information carrier, e.g., in a machine-readable storage device or in a propagated signal, for execution by, or to control the operation of, data processing apparatus, e.g. a programmable processor, a computer or multiple computers. A computer program can be written in any form or programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output.

Processors suitable for execution of a computer program include by way of example, both general and special purpose microprocessors, and any one or more processors of any kind of digital computer. Generally a processor will receive instructions and data from a read-only memory or a random access memory or both. The essential elements of a computer are a processor for executing instructions and one or more devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

To provide for interaction with a user, the invention can be implemented on a computer having a display device such as a CRT (cathode ray tube) or LCD (liquid crystal display) monitor for displaying the mapping to the user and a keyboard and a pointing device such as a mouse or trackball by which the user can provide input to the computer.

The methods and systems described are not limited to particular structures but, rather, can be applied to any structures of data objects.

The invention has been described in terms of particular embodiments. Other embodiments are within the scope of the following claims. For example, the steps of the invention can be performed in a different order and still achieve desirable results. The systems and methods described can be applied to any user interface that allows modification either statically or dynamically, at run time.

The above description of illustrated embodiments of the invention, including what is described in the Abstract, is not limited to be exhaustive or to limit the invention to the precise forms disclosed. While specific embodiments of and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather the scope of the invention is to be determined entirely by the following claims.

What is claimed is:

1. A computer implemented method for data transformation using mapping rules comprising:
defining a data transformation between a source data object and a target data object;
creating an initial mapping of elements from the source data object to the target data object;
applying a predefined mapping rule as a subsequent mapping between the source data object and the target data object; and
displaying the mapping from the source data object to the target data object.

2. The method of claim 1, further comprising receiving a request for the data transformation between the source data object and the target data object.

3. The method of claim 1, wherein defining a transformation further comprises gathering information about the data structures to be mapped.

4. The method of claim 1, further comprising editing the predefined mapping rule.

5. The method of claim 1, wherein the predefined mapping rule is automatically chosen from a plurality of predefined mapping rules.

6. The method of claim 1, further comprising creating a new mapping rule and saving the new mapping rule in a library for reuse.

7. The method of claim 1, wherein the mapping is displayed by using a Graphical User Interface (GUI).

8. The method of claim 1, wherein the data transformation is shown on a display using a collapse/expand mapping feature.

9. A mapping unit for data transformation using mapping rules comprising:
a source data object and a target data object;
a mapping module to define a data transformation between the source data object and the target data object and to create an initial mapping of their elements;
a predefined mapping rule to be applied as a subsequent mapping between the source data object and the target data object; and
a display for showing the default mapping from the source data object to the target data object.

10. The system of claim 9, wherein the mapping module receives a request for the data transformation between the source data object and the target data object.

11. The system of claim 9, further comprising an editor for editing the predefined mapping rule.

12. The system of claim 9, wherein the predefined mapping rule is automatically chosen from a plurality of predefined mapping rules.

13. The system of claim 9, further comprising a library for storing of a newly created mapping rule for reuse.

14. The system of claim 9, wherein the mapping is displayed by using a Graphical User Interface (GUI).

15. The system of claim 9, wherein the data transformation is shown on a display using a collapse/expand mapping feature.

16. A computer program product, tangibly stored on a machine readable medium, for data transformation using mapping rules, the product comprising instructions operable to cause a processor to:
define a data transformation between a source data object and a target data object;
create an initial mapping of elements from the source data object to the target data object;
apply a predefined mapping rule as a subsequent mapping between the source data object and the target data object; and
display the default mapping from the source data object to the target data object.

17. The product of claim 16, further comprising instructions to receive a request for the data transformation between the source data object and the target data object.

18. The product of claim 16, further comprising instructions to gather information about the data structures to be mapped.

19. The product of claim 16, further comprising instructions to edit the predefined mapping rule.

20. The product of claim 16, further comprising instructions to choose automatically the predefined mapping rule from a plurality of predefined mapping rules.

21. The product of claim 16, further comprising instructions to create a new mapping rule and save the new mapping rule in a library for reuse.

22. The product of claim 16, further comprising instructions to display the mapping by using a Graphical User Interface (GUI).

23. The product of claim 16, further comprising instructions to show the data transformation on a display using a collapse/expand mapping feature.
